(19) United States
(12) Patent Application Publication
(10) Pub. No.: US 2006/0190476 A1
(43) Pub. Date: Aug. 24, 2006

(54) Database storage system and associated method

(76) Inventors: Risto Kalvei Mettovaara, Goteborg (SE); Roman Konovalov, Molndal (SE)

Correspondence Address: Siemens Corporation;Intellectual Property Department, 170 Wood Avenue South, Iselin, NJ, 08830, US

(21) Appl. No.: 11/324,820

(22) Filed: Jan. 4, 2006

Related U.S. Application Data
(60) Provisional application No. 60/654,704, filed on Feb. 18, 2005.

(51) Int. Cl. G06F 17/00

(52) U.S. Cl. 707/102

(57) ABSTRACT

A system is provided for saving data to a structurally changed database. The system comprises an input processor for validating ancillary data; a stored procedure generator for automatically re-generating a stored procedure using the validated ancillary data and metadata. The system further comprises a code generator for automatically re-generating source code for the data layer using the validated ancillary data and the metadata.

### CROSS REFERENCE TO RELATED APPLICATIONS

This is a non-provisional application of provisional application Ser. No. 60/654,704 by Risto K. Mettovaara et al. filed Feb. 18, 2005.

### FIELD OF THE INVENTION

The present invention relates generally to database systems, and in particular, to techniques for uniformly saving data in a structurally changed database.

### BACKGROUND OF THE INVENTION

Databases are computerized information storage and retrieval systems. Whenever a database structural change is implemented by a database developer at the request of an end user, there is a significant amount of time lost in manually updating the source code associated with the structural change. As is well known, the source code is comprised of a plurality of stored procedures comprised of executable code directed to an operation associated with saving data to a database. In addition to the time lost in manually upgrading the source code to reflect the structural change there is a susceptibility to software errors due to the non-standard nature of the interfaces to the database. A further problem arises where multiple interfaces are supported by a database management system. For example, a system may provide both high level query language interfaces and database management interfaces. The multiple interfaces may be designed and implemented by different people resulting in different ways of storing data in different database sub-modules. The different interfaces also means that updates occur by manual means involving review and update as necessary of individual code lines.

It would be an improvement over the prior art to have a system and method for providing a uniform way of saving data in a database that has been structurally changed.

### SUMMARY OF THE INVENTION

The invention provides a uniform way to save data to a structurally changed database in the same manner regardless of which database table of the structurally changed database is updated. More particularly, whenever a database table is structurally changed, one or more stored procedures corresponding to the changed database table are automatically regenerated. The automatically regenerated procedures are stored for later use with an end user application to save data to the structurally changed database. This advantageously precludes the need to manually rewrite individual stored procedures thus eliminating the possibility of human error.

According to one aspect, a system comprises an input processor for validating ancillary data to be saved to the structurally changed database, a stored procedure generator for automatically re-generating a stored procedure using the validated ancillary data and metadata, and a code generator for automatically re-generating a source code for the data layer using said validated ancillary data and said metadata.

### BRIEF DESCRIPTION OF THE DRAWINGS

A wide array of potential embodiments can be better understood through the following detailed description and the accompanying drawings in which:

FIG. 1 is a flow diagram illustrating a method performed by a system of the invention,

FIG. 2 is an illustration of how the invention may be used to support an end user application in performing database operations on a structurally updated database,

FIG. 3 illustrates a system of the invention for generating source code and stored procedures for use with an end user application, according to one embodiment, and

FIG. 4 illustrates an example GUI interface for receiving ancillary data from an end user in a system of the invention.

### DEFINITIONS

When the following terms are used herein, the accompanying definitions apply:

database—one or more structured sets of persistent data, usually associated with software to update and query the data. A simple database might be a single file containing many records, where the individual records use the same set of fields. A database can comprise a map wherein various identifiers are organized according to various factors, such as identity, physical location, location on a network, function, etc.

executable application—code or machine readable instructions for implementing predetermined functions including those of an operating system, healthcare information system, or other information processing system, for example, in response to a user command or input.

executable procedure—a segment of code (machine readable instruction), sub-routine, or other distinct section of code or portion of an executable application for performing one or more particular processes and may include performing operations on received input parameters (or in response to received input parameters) and provide resulting output parameters.

information—data

object—comprises a grouping of data, executable instructions or a combination of both or an executable procedure.

processor—a processor is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor.

User Interface—one or more display images enabling user interaction with a processor or other device.

### DETAILED DESCRIPTION

Overview

As is well known to those familiar with the database arts, each table in a database is operated on by one or more associated stored procedures. Whenever a table is structurally changed in accordance with a change request, the one or more stored procedures associated with the changed table are required to be updated to access the structurally changed table. The system and method of the invention updates the one or more associated stored procedures associated with the changed table by automatically re-generating the stored procedures. In addition, associated source code for the data layer, necessary for calling the changed procedures, is updated to replace existing source code. It should be appreciated that certain database fields may not be updated in the manner described herein and are therefore required to be updated internally.

An advantage provided by the invention is the ability to support an end user application in uniformly performing operations (e.g., insertions, deletions, updates) on a structurally changed database regardless of which database table is being updated and which end user is performing the operation. Another advantage provided by the invention concerns a tangible time savings associated with each request to change the database structure. A further advantage is that by automatically re-generating the stored procedures, the chance for database developers to introduce new errors into the newly generated stored procedures, via manual means, is eliminated.

Method

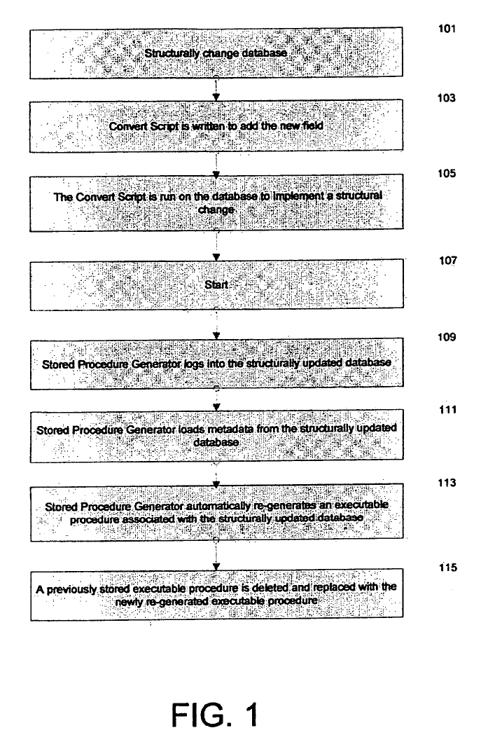

FIG. 1 illustrates a method performed by a system of the invention, according to one embodiment.

Steps 101 through 105 below collectively define a pre-condition directed to implementing a structural change to a database. A structural change is a necessary pre-condition to re-generating stored procedures in accordance with the method of the invention.

At step 101, an end user determines a need to make a structural change in a particular table of a database. The structural change could comprise, for example, adding a new field to a table, deleting a field from a table, a change made to a table field data type, a change to a property of the field to make it accept “a NULL” value, a change to the size of the field (e.g., from string (30) to string (60)).

At step 103, a database designer manually writes a convert script, in SQL, for example, that implements the structural change defined at step 101.

At step 105, the manually written convert script is run on the database to implement the structural update.

At step 107, the method starts

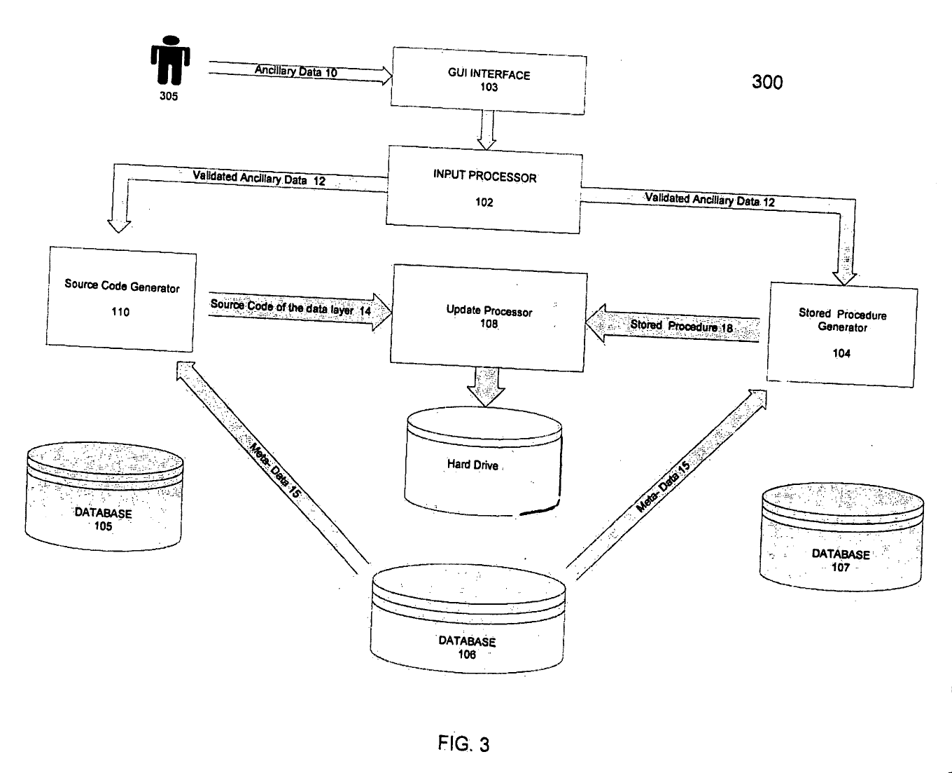

At step 109, a stored procedure generator 104 (as shown in FIG. 3) logs into the database that has been structurally updated at step 105.

At step 111, the stored procedure generator 104 loads metadata from the structurally updated database. The metadata includes information about the various fields which make up the structurally changed database table.

At step 113, using the metadata loaded at step 111, the stored procedure generator 104 automatically re-generates a new stored procedure for inserting, deleting and updating data to the structurally updated database table.

At step 115, the previously existing stored procedure is deleted and replaced with the new stored procedure re-generated at step 113.

Application

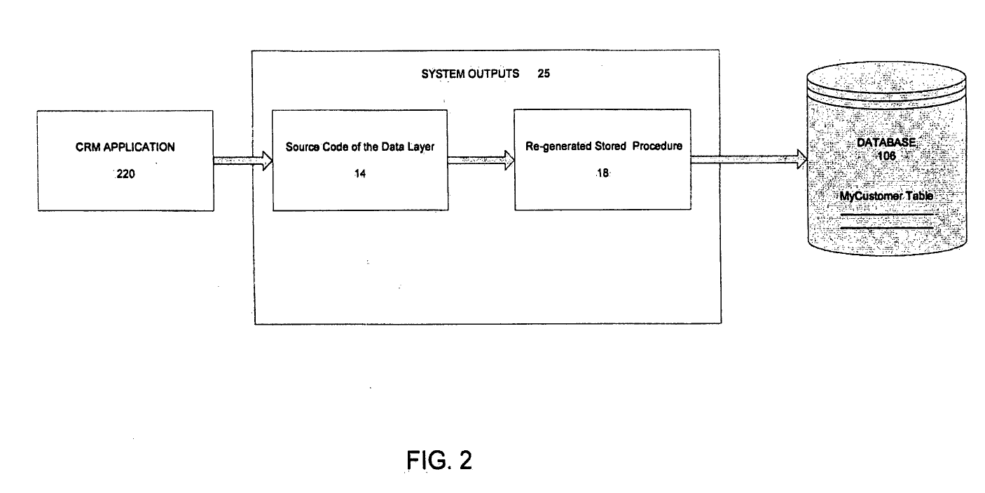

FIG. 2 is an illustration of how the invention may be used to support an end user application in performing database operations on a structurally changed database. An exemplary Customer Relationship Management (CRM) application 220 is shown which has a requirement to add data to a newly created field (e.g., “Age” field) to the “MyCustomers” table of database 106. It should be understood that the addition of the “age” field to the “MyCustomers” table of the database 106 constitutes a structural change to the database 106. As described briefly above with respect to the flowchart of FIG. 1, a structural database change constitutes the necessary pre-condition prior to implementing the method of the invention. Subsequent to making a structural change, associated source code for the data layer 14 and at least one stored procedure 18 are re-generated to reflect the database structural change. The re-generated source code for the data layer 14 and the at least one stored procedure 18 are stored to support an end user application, described by way of example as follows.

FIG. 2 shows two system outputs 25 which support an exemplary end user CRM application 220. Specifically, the two system outputs 25 support the end user CRM application 220 by facilitating the saving of data to the “MyCustomers” table of database 106, which has been structurally changed in satisfaction of the afore-mentioned pre-condition. The two system outputs 25 provide support to the exemplary end user CRM application 220 to perform database operations on the changed database by knowing how data is stored in the database 106 and where the database 106 is located. It should be understood that the CRM application 220 is incapable of performing the save directly because it has no knowledge of how data is stored in the database 106 or where the database 106 is located. This limited knowledge on the part of an end user application is commonly referred to in the art as data encapsulation, whereby an application is intentionally constructed independently from an underlying database with which it interacts.

In the exemplary CRM application 220 of FIG. 2, changed data reflecting the structural addition of the “Age” field, is output from the CRM application 220 in a standard format, such as, for example, Recordset™. A recordset is a Microsoft object oriented data structure that consists of a group of database records, and can either come from a base table or as the result of a query to the table. The changed data is intended to be saved in the structurally changed database 106 by the CRM application 220.

The changed data is provided from the CRM application 220 to the source code for the data layer 14, one of the two system outputs 25. Upon receiving the changed data, the source code for the data layer 14 unpacks the changed data and converts the unpacked changed data from the standard format into a different format deemed to be acceptable by the re-generated stored procedure 18, the second system output 25. It should be understood that the two system outputs 25 are generated in accordance with the system diagram of FIG. 3, described further below.

In addition to unpacking the data and changing the data format, the source code for the data layer 14 validates the changed data received from the CRM application 220. Validation includes determining that the data can be safely forwarded to the re-generated stored procedure 18. Validation may include, for example, determining whether there is any missing data that is required by the re-generated stored procedure 18, or whether the particular field length exceeds the allowed length for the respective table field. In the case of missing data or any other data violation, the source code 14 sends an error message back to the CRM application 220. It should be appreciated that the validation check performed by the source code 14 prevents errors from occurring at the database layer (not shown) which are more problematic in that they cause the system to use more resources than is otherwise required by performing the check beforehand in the manner described herein.

Subsequent to unpacking, validating and changing data received by the source code 14 for the data layer, the automatically re-generated stored procedure 18 is called to provide the unpacked, validated and changed data. The automatically re-generated stored procedure 18 saves the validated data to the structurally changed “MyCustomers” table of database 106.

In sum, it is therefore shown that the two system outputs 25, namely, the source code for the data layer 14 and the automatically re-generated stored procedure 18 support the exemplary end user CRM application 220 to save data to a structurally changed database 106.

In should be understood that source code 14 may be written in any high level programming language including, without limitation, C++, Java, Visual Basic and the like.

### SYSTEM

A system 300 for storing data in a structurally updated database 106 is now described, with reference to FIG. 3, according to one embodiment. The system 300 includes a GUI interface 103 for receiving ancillary data 10 from an end user 305, an input processor 102 for validating the received ancillary data, a stored procedure generator 104 for automatically re-generating a stored procedure 18 using the validated ancillary data and metadata obtained from a structurally changed database 106. As shown in FIG. 3, in a typical configuration, there are multiple databases 105, 106, 107 which may be structurally changed. The system 300 further includes a source code generator 110 for automatically re-generating source code for the data layer 14 using the validated ancillary data and the metadata. The system 300 further includes an update processor for replacing an existing stored procedure with the re-generated stored procedure 18 and for replacing existing source code for the data layer with re-generated source code for the data layer 14. The process for re-generating the source code for the data layer 14 and the stored procedure 18, are described further below. First, a description of what constitutes ancillary data 10 is provided as follows.

The ancillary data 10, provided via the GUI interface, includes information regarding: (a) which structurally changed database 105-107 to operate on (e.g., in the instant example, three databases are shown, i.e., 105-107 of which one database 106 is selected to be operated on), (b) the particular table and the table's associated fields in the database 106 selected at step a, (c) the particular operation (e.g., insert, save, deleted, update) to be performed on information contained within the identified table and associated fields of the database selected at step a, and (d) the name of at least one existing stored procedure 18 to be re-generated to carry out those operations identified at step c.

The ancillary data 10 is provided by the GUI interface 103 to an input processor 102 for validation. The input processor outputs validated ancillary output data 12 to both a source code generator 110 and a stored procedure generator 104.

Re-generating Source Code for the data layer 14

The Source Code Generator module 110 uses the validated ancillary data 12, provided by the input processor 102 and meta-data 15, obtained from the structurally changed database 106, to generate source code for the data layer 14 (as shown in FIG. 2) as a first system output 25 to be stored by the update processor 108 as a file on a hard drive 120, or similar storage medium, for future use with an end user application such as the exemplary CRM application 220 described with reference to FIG. 2. The re-generated source code for the data layer 14 is generated as a single file comprised of a number of separate source code functions for each database operation to be updated (e.g., insert, update, delete, etc.). Each re-generated source code function requires recordset information as an input parameter where each field of the recordset information corresponds to a field of the structurally changed database table. Each source code function contain code that extracts recordset information provided by an end user application such as the exemplary CRM application 220 described with reference to FIG. 2, and converts the extracted recordset information to a format corresponding to input parameters required by a corresponding re-generated stored procedure 18. If there is a field in the recordset information that does not allow the NULL value to be saved in it, the re-generated source code function contains code that checks to ensure that the respective data in the recordset information is not empty.

Re-generating a stored procedure 18

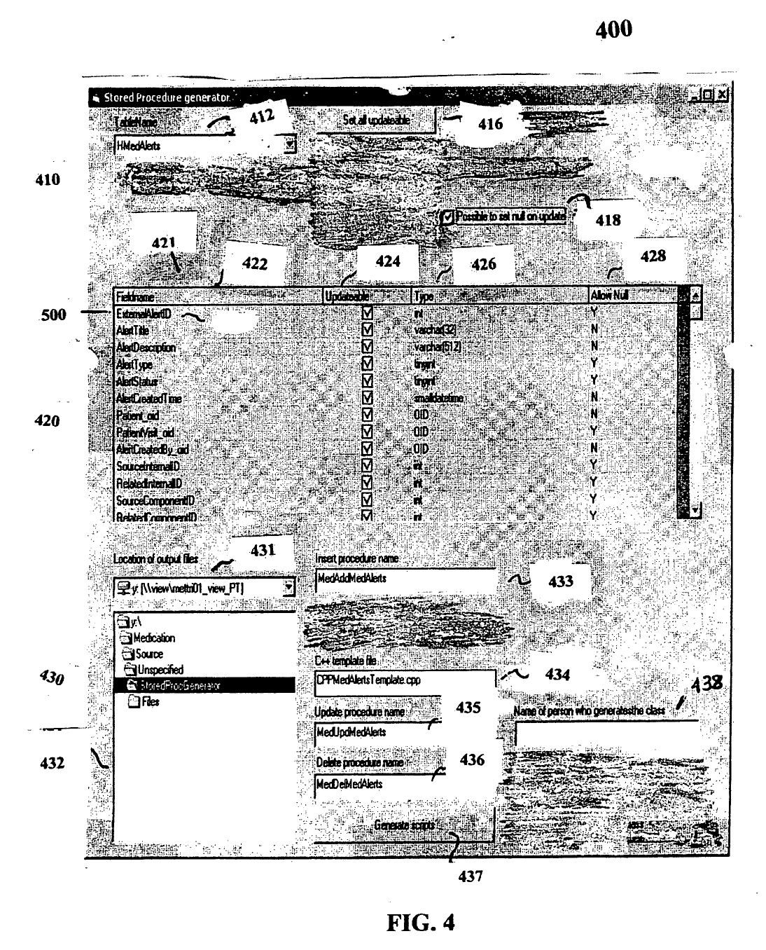

The Stored Generator module 104 uses the validated ancillary data 12, provided by the input processor 102 and meta-data 15, obtained from the structurally changed database 106, to automatically re-generate and output a stored procedure 18 as a second system output 25. The re-generated stored procedure 18 is stored by the update processor 108 as a file on a hard drive 120, or similar storage medium, for future use with an end user application such as the exemplary CRM application 220 described with reference to FIG. 2. The metadata 15 comprises the database's defined fields and the fields' properties. The ancillary data comprises the name and location of the structurally changed database 106, the particular table in the structurally changed database 106 to re-generate code for, the fields in the particular table that are allowed to be updated and the type of code to be re-generated (i.e., update, insert, delete, etc.). The ancillary data 12 is obtained from a user via a GUI interface 400, in a manner described below with reference to FIG. 4.

Using the meta-data 15 and the ancillary data as inputs, the stored procedure generator 104 re-generates a stored procedure 18 by creating a text file that contains code directed to a specific data operation such as, for example, inserting, updating or deleting data in a structurally changed database 106. A single text file (i.e., re-generated stored procedure 18) replaces a corresponding existing stored procedure. The code contained in the text file comprises standard SQL. It is further noted that a user has the option of selecting a user preferred name for a text file (i.e., a re-generated stored procedure 18), or may otherwise use the default name of the currently stored procedure.

The re-generated source code for the data layer 14 and at least one re-generated stored procedure 18 respectively replace the currently stored source code for the data layer 14 and stored procedure 18, respectively, which were used prior to the structural database change.

Metadata

The metadata 15, referred to above, includes information about the various database fields which make up the specified table of the structurally changed database 106 to regenerate the source code 14 and stored procedures 18. The metadata 15 is accessed by the stored procedure generator 104 from one or more tables configured to store metadata in the structurally changed database 106.

User Interface

FIG. 4 illustrates an example GUI interface 400 for receiving the ancillary data 10 from an end user in a system of the invention, as described above with reference to FIG. 3. Along a top area 410 of the interface 400, a drop down list box (DDLB) on the upper right of the interface 400, labeled “Tablename” 412, allows a user to select a table name from among a plurality of table names in the database 106. The user selected table name refers to a database table that has been structurally changed.

To the right of the “Tablename” drop down list box 412, there is shown a selectable button, labeled “Set all updateable” 416 which sets the fields of the user selected database table 412 that are allowed to be changed. In other words, the update property of those fields of the user selected database table 412 are set to “true” which allow the CRM application 220 to update data stored in the field. The top area 410 further includes a check box labeled “Possible to set null on update” 418 which defines whether the re-generated source code for the data layer 14 and the re-generated stored procedures 18, accepts the null value as a valid value to be stored in the table of the database 106 selected via the “Tablename” drop down list box 412.

In a central region 420 of the interface 400, a list box 421 is shown comprised of a plurality of rows where each row corresponds to information pertaining to the database table selected via the “Tablename” drop down list box 412.

The first column 422 of the list box 421, labeled “Fieldname” 422, indicates a particular field in the database table selected via the “Tablename” drop down list box 412. For example, in the exemplary interface 400 shown, the first row 500 refers to the “ExternalAlertID” field of the “HmedAlerts” table 412.

The second column of the list box 421, labeled “Updateable” 424, indicates whether the particular field identified in the first column 422 is allowed to be changed by a re-generated stored procedure 18 for updating the user selected database table 412. This is a required field because certain fields cannot be changed by a stored procedure and can only be changed through internal system logic.

The third column of the list box 421, labeled “Type” 426, indicates the field type, (e.g., integer, character and so on) of the particular field identified in the first column 422. For example, referring again to the first row 500, the “ExternalAlertID” field identified in the first column 421, is an integer “int” type 426.

The fourth column of the list box 421, labeled “Allow Null” 428, specifies whether the field identified in the first row 424 allows null values to be saved to the user selected database table 412, from the top area 410 of the interface 400.

In the lower region 430 of the interface 400, there is illustrated a second drop down list box labeled, “Location of output files” 431 which specifies where the re-generated stored procedure 18 is to be stored. A user selects a storage location by navigating with the hierarchical tree structure 432 located directly beneath the “Location of output files” drop down list box 431. To the right of the “Location of output files” drop down list box 431 there is shown a number of vertically aligned user input boxes including a “Insert procedure name” input box 433, a C++ template file input box 434, an “Update procedure name” input box 435 and a “Delete procedure name” box 436. The “Insert procedure name” input box 433 defines the name of an existing stored procedure 18 to be re-generated in accordance with the invention to structurally update the database table defined by the database table 412 in the top area 410. The C++ template file input box 434 defines the name of the file storing the source code for the data layer 14 to be generated by a system of the invention. The “Update procedure name” input box 435 and the “Delete procedure name” box 436 define the names of executable procedures 18 that are to be re-generated for updating and deleting data respectively. The “Generate scripts” button 437 is used to generate the source code for the data layer 14 and a stored procedure 18 according to the information provided by the end user via the interface 400. To the right of the “Update procedure name” input box 435 there is shown a “Name of person who generates the class” box 438 which identifies the person providing the ancillary data 10 to the interface 400.

The invention will now be described in detail by way of example, it being understood that this example is intended to be illustrative only and the invention is not intended to be limited to the details of the described embodiment. Appendix A includes computer source code in accordance with the provided example thereby enabling one having ordinary skill in the art to make the invention. It is noted that the example description and associated reference numbers refer to the code example of Appendix A. Specifically, exemplary InsertCustomer.sql [30], UpdateCustomer.sql [40] and CustomerData.cpp [50] source code examples are provided in Appendix A. It should be understood that the Stored Procedure Generator 104 (as shown in FIG. 3) automatically generates the InsertCustomer.sql [30] and UpdateCustomer.sql [40] files and the Source Code Generator 110 (as shown in FIG. 3) automatically generates the CustomerData.cpp file [50]. In other embodiments of the invention, the inventive concept may be implemented in other computer code, in computer hardware, in other circuitry, in a combination of these, or otherwise. Appendix A is hereby incorporated by reference in its entirety and is considered to be a part of the disclosure of this specification.

### EXAMPLE

Consider a database, i.e., “Customerdatabase”, that contains a single table, “Customers” [20] comprised of four fields, i.e., “FirstName” [31], “SecondName” [33], “PhoneNo” [35] and “NoOfOrders” [37]. Assume that there is a requirement to add a new field, “EmailAddress” [39] to the “Customers” [20] table. A structural change to the database is made to add the new field by writing a database change script and running the script against the “Customerdatabase” database. Subsequent to implementing the structural change via the script, application's data layer, the Stored Generator module 104 is run to update the source code and stored procedures associated with the structurally changed table. To update (i.e., automatically re-generate) the source code and stored procedures, the Stored Generator module 104 (as shown in FIG. 1) uses validated ancillary data 12, provided by a user via the input processor 102 and meta-data 15, obtained from the structurally changed database 106. Once created, the re-generated stored procedure 18 is stored by the update processor 108 as a file on a hard disk 120, or similar storage medium, for future use with an end user application such as the exemplary CRM application 220 described above.

In the present example, the meta-data and validated ancillary data, obtained by the Stored Generator module 104 comprise the following:

Meta-data

The Stored Generator module 104 accesses meta-data 15 from the “Customers” [20] table comprising the following:
(a) FirstName [31] is of type String, has 50 symbols as length and does not allow NULL values to be saved in it.
(b) SecondName [33] is of type String, has 50 symbols as length and does not allow NULL values to be saved in it.
(c) PhoneNo [35] is of type String, has 20 symbols as length and allows NULL values.
(d) NoOfOrders [37] is of type Integer and does not allow NULL value.
(e) EmailAddress [39] is of type String, has 30 symbols as length and allows NULL values.
   Validated Ancillary Data

For purposes of illustration, it is assumed that the “NoOfOrders” field [37] is not allowed to be updated by an end-user application because it is a field that is updated each time a customer creates a new order. Hence, a user is not able to manually update the number of orders the customer has. The ancillary data comprises:
(a) Database name is “Customerdatabase” (note: not explicitly referred to in the code sections below)
(b) Table name is “Customers” [20]
(c) Fields allowed for updates: FirstName [31], SecondName [33], PhoneNo [35] and EmailAddress [39]
   Re-generating the Stored Procedures and associated calling functions

In the present example, it is further assumed that a developer has selected to re-generate stored procedures 18 for two database operations, i.e., Insert and Update, associated with the structurally changed “Customers” [20] table. The re-generated stored procedures 18 are saved in the source code files, InsertCustomer.sql [30] and UpdateCustomer.sql [40], respectively, on a hard drive 120. The re-generated stored procedures 18 for the Insert and Update operations require respective calling functions which are re-generated and stored as a singe source code file, CustomerData.cpp [50], by the Source Code Generator 110.

Although this invention has been described with reference to particular embodiments, it should be appreciated that many variations can be resorted to without departing from the spirit and scope of this invention as set forth in the appended claims. The specification and drawings are accordingly to be regarded in an illustrative manner and are not intended to limit the scope of the appended claims.

What is claimed is:

1. A system for saving data to a structurally changed database, comprising:
an input processor for validating ancillary data;
5 a stored procedure generator for automatically re-generating a stored procedure using said validated ancillary data and metadata; and
a code generator for automatically re-generating source code for a data layer using said validated ancillary data and said metadata.

2. A system according to claim 1, further comprising an update processor for replacing an existing stored procedure with said re-generated stored procedure and for replacing existing source code for the data layer with said re-generated source code for the data layer.

3. A system according to claim 2, further comprising storage means for storing said re-generated stored procedure and said re-generated source code for the data layer.

4. A system according to claim 1, wherein said metadata comprises information regarding fields of at least one structurally changed table of the structurally changed database 106

5. A system according to claim 4, wherein said metadata comprises at least one of, (a) a database identifier, (b) one or more tables of the identified database, (c) an operation identifier, and (d) a stored procedure identifier.

6. A system according to claim 1, wherein said ancillary data comprises information including at least one of, (a) a structurally changed database, (b) a table and associated fields of the structurally changed database, (c) a particular operation to be performed on information contained within the particular table and the table's associated fields in the structurally changed database, and (d) an existing stored procedure identifier.

7. A system according to claim 1, wherein said source code for a data layer is configured to: (a) unpack data received in a first data format, (b) validate said unpacked data, (c) convert said validated data from said first data format to a second data format acceptable by a re-generated stored procedure, and (d) provide said converted data to said re-generated stored procedure.

8. A system according to claim 1, wherein said at least one stored procedure is configured to: (a) add new data into a selected table of the structurally changed database, (b) update existing data from the selected table of the structurally changed database, (c) retrieve data from the selected table of the structurally changed database.

9. A method for saving data to a structurally changed database, comprising the acts of:
unpacking data in a first format received from an end user application;
validating the unpacked data;
converting the validated data from said first format to a second format acceptable by a re-generated stored procedure;
providing the converted data to the re-generated stored procedure; and
saving the converted data to the structurally changed database.

10. A method for re-generating at least one calling function for calling a re-generated stored procedure for performing a particular database operation on at least one structurally changed table of a structurally changed database, the method comprising the steps of:
receiving ancillary data from a user;
retrieving metadata from the structurally changed table of a structurally changed database;
re-generating the at least one calling function from the received ancillary data and metadata; and
replacing at least one existing calling function with the re-generated at least one calling function.

11. The method of claim 10, wherein said ancillary data comprises information including at least one of, (a) a structurally changed database, (b) a table and associated fields of the structurally changed database, (c) a particular operation to be performed on information contained within the particular table and the table's associated fields in the structurally changed database, and (d) an existing stored procedure identifier.

12. A system according to claim 10, wherein said metadata comprises information regarding fields of at the at least one structurally changed table of the structurally changed database.

13. The method of claim 12, wherein said metadata comprises at least one of, (a) a database identifier, (b) one or more tables of the identified database, (c) an operation identifier, and (d) a stored procedure identifier.

14. A method for re-generating at least one for stored procedure for performing a particular database operation on at least one structurally changed table of a structurally changed database, the method comprising the steps of:
receiving ancillary data from a user;
retrieving metadata from the structurally changed database;
re-generating the at least one stored procedure from said received ancillary data and said metadata; and
replacing an existing at least one stored procedure with the corresponding re-generated at least one stored procedure.

15. The method of claim 14, wherein said ancillary data comprises information including at least one of, (a) a structurally changed database, (b) a table and associated fields of the structurally changed database, (c) a particular operation to be performed on information contained within the particular table and the table's associated. fields in the structurally changed database, and (d) an existing stored procedure identifier.

16. The method of claim 14, wherein said metadata comprises at least one of, (a) a database identifier, (b) one or more tables of the identified database, (c) an operation identifier, and (d) a stored procedure identifier.
